(19) United States
(12) Patent Application Publication
(10) Pub. No.: US 2018/0217855 A1
(43) Pub. Date: Aug. 2, 2018

(54) ESTIMATING WAIT TIMES FOR REQUESTS

(71) Applicant: Google Inc., Mountain View, CA (US)

(72) Inventors: Eric Strellis, Mountain View, CA (US); Thunder J. Parley, San Jose, CA (US)

(21) Appl. No.: 14/094,659

(22) Filed: Dec. 2, 2013

Related U.S. Application Data
(63) Continuation of application No. 13/006,881, filed on Jan. 14, 2011, now abandoned.

(51) Int. Cl. G06F 9/455

(52) U.S. Cl. CPC G06F 9/455

(57) ABSTRACT

Methods, systems, and computer program products are provided for estimating wait times for requests. One example method in identifying requests in a queue where each request includes a category, identifying a list of agents for servicing the requests including identifying agent capabilities for servicing particular request categories, running a simulation to determine an estimated wait time for a specific request in the queue, and providing an estimate of the wait time based on the simulation.

### BACKGROUND

This specification generally relates to performing data manipulation.

Help systems, such as phone-based and Internet-based systems, can match users requesting information or assistance with personnel who may be able to assist the users. If the number of personnel employed by the help system is insufficient for assisting all of the users that request assistance at any one time, the users may be placed in a queue. The users wait their turn before being assigned to an available assistant.

### SUMMARY

In general, one innovative aspect of the subject matter described in this specification may be embodied in methods, systems, and computer program products for estimating wait times for requests. One example method includes identifying requests in a queue where each request includes a category, identifying a list of agents for servicing the requests including identifying capabilities of the agents to service particular request categories, running a simulation to determine an estimated wait time for a specific request in the queue, and providing an estimate of the wait time based on the simulation. The simulation can include assigning agents service requests based on their capabilities and accumulating a wait time based on how many agents are required to service the queue up to a point in time for servicing the specific request.

In general, another innovative aspect of the subject matter described in this specification may be embodied in methods that include the actions of identifying requests in a queue where each request includes a category, identifying a list of agents for servicing the requests including identifying capabilities of the agents to service particular request categories, and running a simulation to determine an estimated wait time for a specific request in the queue. The simulation can include the steps of assigning an agent from a top of the list to an oldest request in the queue that the agent has a capability to service, identifying an estimated amount of time required to service the oldest request by the agent, adding the agent back to the sorted list of agents with an availability time for the agent being associated with the identified estimate, and repeating the steps until an agent is identified to service the specific request. An estimate of the wait time can be provided based on the simulation.

These and other embodiments may each optionally include none, one or more of the following features. In various examples, the requests can be questions posed in a chat help queue. The category can include a topic. The category can include a topic and a language. Categorizing the requests based on category can include sorting the requests into a plurality of pools based on the category. The requests can be sorted based on arrival time. Sorting the requests can be based in part on priority of the requests.

The list of agents can be sorted based on availability of the agents to service requests. An agent's capabilities can be measured in terms of one or more thresholds, and determining a request in the simulation that can be serviced by a given agent can include determining if the agent is sufficiently capable to service the request, where sufficiency is measured based on one or more criteria. The criteria can be a number of other agents in the list that have a minimum capability to service the request. The criteria can be a number of requests of a given type that are in the queue. Agents can be capable of working on a plurality of N requests at one time, and an agent can be added hack to the sorted list of agents with an availability time for the agent being associated with the estimated time/N. Running the simulation can include removing agents from the simulation if they do not have a capability to service any requests in the queue. Running the simulation can include ending the simulation if the list of available agents reaches zero.

Providing the estimate can include compensating for simulation start up error when providing the estimate. Compensating for simulation start-up error can include adjusting an amount of time of delay in answering a first question by an agent by an amount equal to approximately one half of a historical average. Providing the estimate can include providing an estimate that indicates that no agents are presently available to service the request. Providing the estimate can include determining a number of questions that the agent that has been identified to process the specific request has processed in the simulation prior to being available to process the specific request, and multiplying an average processing time associated with the agent by the number of questions to produce the estimate. Providing the estimate can include maintaining a cumulative total of estimated handling times for requests that the agent that has been identified to process the specific request has processed in the simulation prior to being available to process the specific request. When determining a wait time associated with processing a first request by a given agent, the estimated wait time can be reduced by one half of an average processing time associated with the agent.

Particular embodiments of the subject matter described in this specification may be implemented to realize none, one or more of the following advantages. Accurate information regarding wait times for requests can be provided to users, taking into account different categories of requests submitted by the users, and different capabilities of agents. Agents in multi-agent environments can be employed effectively and efficiently. Users can receive timely assistance from agents capable of servicing their requests. Wait time estimates can be adjusted for skew in distribution of requests for information with respect to agent capabilities.

The details of one or more embodiments of the subject matter described in this specification are set forth in the accompanying drawings and the description below. Other potential features, aspects, and advantages of the subject matter will become apparent from the description, the drawings, and the claims.

### BRIEF DESCRIPTION OF DRAWINGS

FIG. 1 is a diagram of an example system that can estimate wait times for requests.

FIG. 2 is a diagram of an example system that can categorize requests.

FIG. 3 is a flowchart of an example process for estimating wait times for requests.

FIG. 4 is a flowchart of an example process for running a simulation to determine estimated wait times.

FIG. 5 is a flowchart of an example process for estimating wait times for requests.

FIG. 6 shows an example of a computer device and a mobile computer device that can be used to implement the techniques described here.

Like reference symbols in the various drawings indicate like elements.

### DETAILED DESCRIPTION

In general, a system estimates wait times for users that submit requests for information (e.g., questions) to be handled by agents (e.g., support personnel). The requests can be added to a queue, and agents capable of handling the requests can be identified. For example, a request may be associated with one or more categories, and agents having expertise or experience related to the categories can be identified as having a capability to service the request. To estimate user wait times, the system can run a simulation based in part on agent availability, on agent capability, and on historical averages for handling requests. Wait time estimates produced by the simulation can be provided to users.

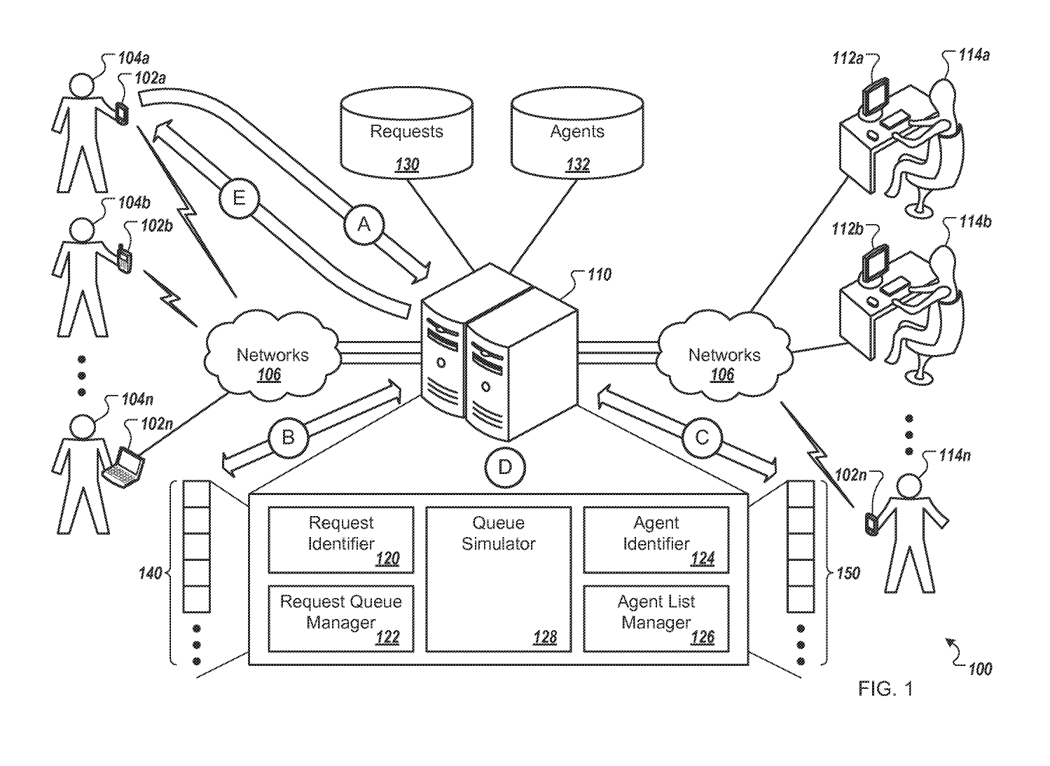

FIG. 1 is a diagram of an example system 100 that can estimate wait times for requests. FIG. 1 also illustrates an example flow of data within the system 100 during states (A) to (E), where the states (A) to (E) may occur in the illustrated sequence, or they may occur in a sequence that is different than in the illustrated sequence.

In further detail, the system 100 includes one or more client computing devices 102 (each operated by a user 104) which communicates over one or more networks 106 with one or more computing servers 110. The system 100 also includes one or more client computing devices 112 (each operated by an agent 114) which communicates aver the network(s) 106 with the computing server(s) 110. The networks 106 may include a wireless cellular network, a wireless local area network (WLAN) or WiFi network, a Third Generation (3G) or Fourth Generation (4G) mobile telecommunications network, a private network such as an intranet, a public network such as the Internet, or any appropriate combination thereof.

The client devices 102, 112 may be any appropriate type of computing device (e.g., mobile phone, smart phone, PDA, music player, e-book reader, tablet computer, laptop or desktop computer, or other stationary or portable device) that includes one or more processors and computer readable media. Among other components, for example, the client devices 102, 112 include one or more processors, computer readable media that store software applications, input device(s) (e.g., touch screens, keyboards, computer mice, motion sensors and the like), output device(s) (e.g., display screens, speakers, and the like), and communications interfaces.

The computing server(s) 110 may be configured to execute application code associated with a variety of software components (e.g., modules, objects, libraries, services, and the like) including a request identifier 120, a request queue manager 122, an agent identifier 124, an agent list manager 126, and a queue simulator 128. Two or more of the components 120, 122, 124, 126, and 128 may be implemented on the same computing device, or on different computing devices, such as devices included in a server farm or a peer-to-peer network.

The computing server(s) 110 may be configured to access and maintain data stored by a requests data store 130 and an agents data store 132. For example, the requests data store 130 can be used to maintain data related to requests for information submitted by the users 104, including information related to question types and categories. The agents data store 132, for example, can be used to maintain data related to the agents 114, including information related to agent capabilities and agent processing of requests for information.

Referring to the example flow of data, during state (A), the user 104a employs the client device 102a to submit a request. For example, the request may include a question to be handled by support personnel. The computing server 110 can receive the request and can add the request to a request queue 140. For example, the request queue 140 can be maintained using static and/or dynamic memory structures managed by the computing server(s) 110.

During state (B), the computing server(s) 110 can identify requests submitted by the users 104. For example, the computing server(s) 110 can use the request identifier 120 to identify the request in the request queue 140 submitted by the user 104a. In some implementations, users may provide category information (e.g., topics, subjects, languages) with the requests. For example, the users 104 can provide category information using one or more configuration interfaces. In some implementations, the computing server(s) 110 may derive category information from the submitted requests. For example, the request identifier 120 can parse text included in the request submitted by the user 104a to identify keyword information, and the keyword information can be referenced (e.g., against request information provided by the requests data store 130) to identify one or more categories related to the request. As another example, text can be parsed to identify the preferred language of the user 104a.

The computing server(s) 110 can use the request queue manager 122 to sort requests based on arrival time. In the present example, as the computing server(s) 110 may have received a request from the user 104a after receiving requests from other users 104, the request queue manager 122 may place the request from the user 104a at the end of the request queue 140. As other users 104 submit additional requests, for example, the request queue manager 122 may similarly add such requests to the end of the queue 140. As requests are handled by agents 114, for example, the request queue manager 122 may remove the handled requests from the queue 140. If a particular user 104 were to cancel his or her request, for example, the request queue manager 122 may remove the canceled request from the queue 140.

During state (C), the computing server(s) 110 can identify agents 114 for servicing the requests, and can determine agent availability. For example, the computing server(s) 110 can use the agent identifier 124 to identify agents 114 in an agent list 150. The agent list 150 can be maintained using static and/or dynamic memory structures managed by the computing server(s) 110, for example. Identifying the list of agents can include identifying one or more capabilities for the agents 114 to service particular categories of requests. For example, the agents 114 may have different areas of expertise, different user interaction skills, different language skills, different authority levels, and so forth. In some implementations, the agents 114 may be associated with a particular organization (e.g., employees or representatives of business). In some implementations, the agents 114 may be part of a community of users (e.g., some or all of the users 104 may also be agents 114). Information related to the capabilities of the agents 114 can be maintained by the agents data store 132, and can be used by the agent identifier 124 for identifying agents.

The computing server(s) 110 can use the agent list manager to sort the agents 114 based on the ability to service requests. For example, idle agents may be placed at or near the top of the agent list 150. Occupied agents may be sorted by the agent list manager 126 further down the agent list 150, for example, based on projected availability. For example, information maintained by the agents data store 132 may be provided to agent list manager 126 for determining availability of each of the agents 114 in the agent list 150. As agents 114 become available to handle user requests (e.g., as they log into the system 100), the agent list manager 126 may add the agents to the agent list 150. As the agents 114 become unavailable (e.g., as they log out), the agent list manager 126 may remove the agents from the agent list 150.

During state (D), the computing server(s) 110 can run a simulation to determine wait times for user requests. For example, the computing server(s) 110 can use the queue simulator 128 to determine an estimated wait time for the request in the request queue 140 submitted by the user 104a. Generally, the simulation can include assigning the agent at the top of the agent list 150 to the oldest request in the request queue 140 that the agent has a capability to service. The amount of time required to service the request can be estimated, and the agent can be added back to the agent list with an availability time associated with the estimate. The process may be repeated until an agent is identified to service a specific request.

During state (E), the computing server(s) 110 can provide an estimate of the wait time based on the simulation. For example, the computing server(s) 110 can provide to the client device 102a information associated with the estimated wait time for a response to the request submitted by the user 104a. The client device 102a can present such information to the user 104a, for example, through a visual and/or audio interface. In some implementations, the information may be updated periodically. For example, one or more other users 104 with requests higher in the request queue 140 relative to the request submitted by the user 104a may cancel their requests before receiving assistance from one or more agents 114, and the queue simulator 128 may recalculate an estimated wait time for the user 104a to take the cancellations into account. As another possibility, one or more agents 114 may log in or log out of the system 100 before the request submitted by the user 104a is handled. Thus, the queue simulator 128 can adjust the simulation to recalculate estimated wait times for the users 104 as conditions change, and can provide the recalculated wait times to the users.

By running simulations, for example, the computing server(s) 110 in the system 100 can provide the users 104 with accurate information regarding wait times for requests, while taking into account different categories of requests submitted by the users, and different capabilities of the agents 114.

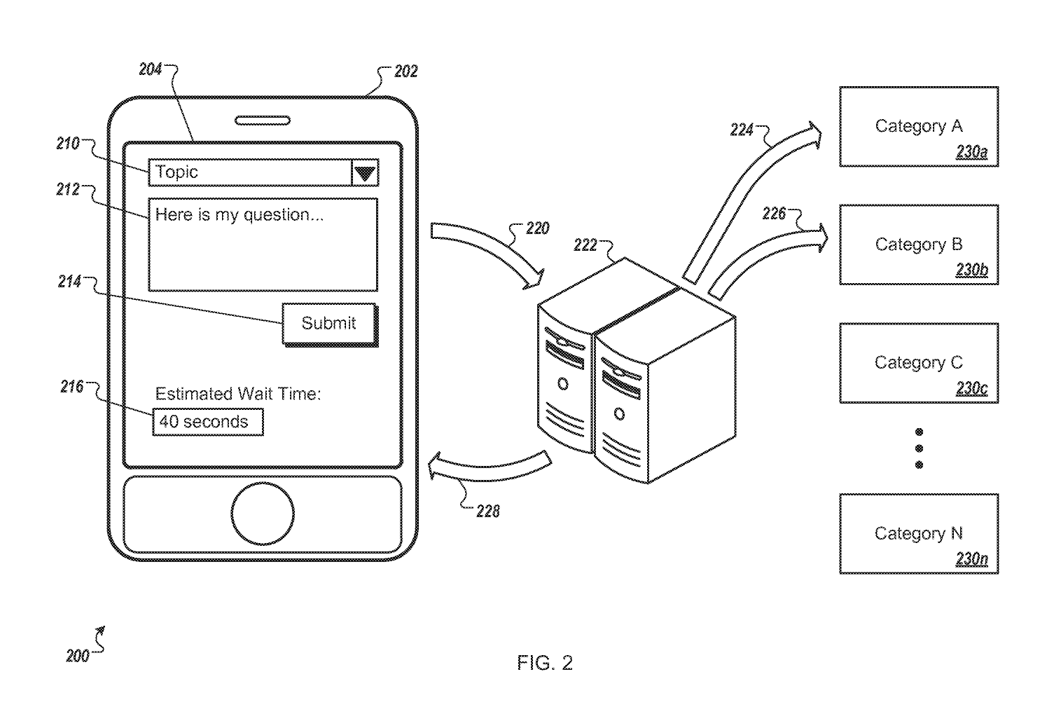

FIG. 2 is a diagram of an example system 200 that can categorize requests. In some implementations, the system 200 may be included in or may be in communication with the system 100 (shown in FIG. 1). For example, the computing server(s) 110 can be configured to categorize requests or to receive categorization information.

The system 200 includes a client computing device 202. Similar to client devices 102, 112 (shown in FIG. 1), for example, the client computing device 202 may be any appropriate type of computing device that includes one or more processors and computer readable media. The client device 202 includes an interface 204 that can enable a device user to submit requests (e.g., questions) for handling by one or more agents. For example, the interface 204 can include visual, audio and tactile sensors, controls, and feedback mechanisms.

In some implementations, the interface 204 can include a topic control 210 and/or a request control 212. For example, the topic control 210 can include a list of request topics selectable by the device user. The user can employ the request control 212 to enter a particular request for information, for example, using one or more text or voice input devices. Upon selecting a topic and/or entering the request, for example, the user can submit topic and request information by interacting with a submission control 214.

As shown by arrow 220, the topic and/or request can be received by computing server(s) 222. Similar to computing server 110 (shown in FIG. 1), for example, the computing server(s) 222 may be configured to execute application code associated with a variety of software components for identifying and categorizing requests, identifying agent capabilities, and providing estimated wait times for requests. The computing server(s) 222 may determine that the topic and/or request submitted by the user relates to one or more categories. In the present example, as shown by arrows 224, 226, the computing server(s) 222 may identify relationships between the submitted topic and/or request and categories 230a and 230b.

In some implementations, categories may include topic information. For example, the categories 230 may relate to general classes of products, services, or problems and the list of topics selectable by the user through the topic control 210 may include various subclasses of the general classes. The computing server(s) 222 can include a mechanism (e.g., a mapping function) for relating specific topics to general categories. As another example, a category may be associated with a list of related keywords. For example, request information submitted by the user through the request control 212 can be analyzed by the computing server(s) 222, and the request information can be mapped to one or more categories 230 using the list of keywords.

In some implementations, categories may include topics and languages For example, categories 230a, 230b, and 230c may each be associated with a similar class of products, services, or problems, but with different languages. It may be determined by the computing server(s) 222, for example, that the user of the device 202 has submitted a topic and/or request related to a particular category, end that the user has a preference for one or more languages. For example, topic and/or request information submitted by the user can be analyzed to identify language preferences. As another example, language preferences may be directly provided by the user.

The computing server(s) 222 can identify one or more agents for servicing the user request. In the present example, the computing server(s) 222 can identify the capabilities of one or more agents to service the categories 230a, 230b, the agents can be sorted, and a simulation can be run to determine an estimated wait time for the request. As shown by arrow 228, the wait time estimate is provided to the client device 202, and information associated with the estimate is presented to the user through an estimate reporting control 216.

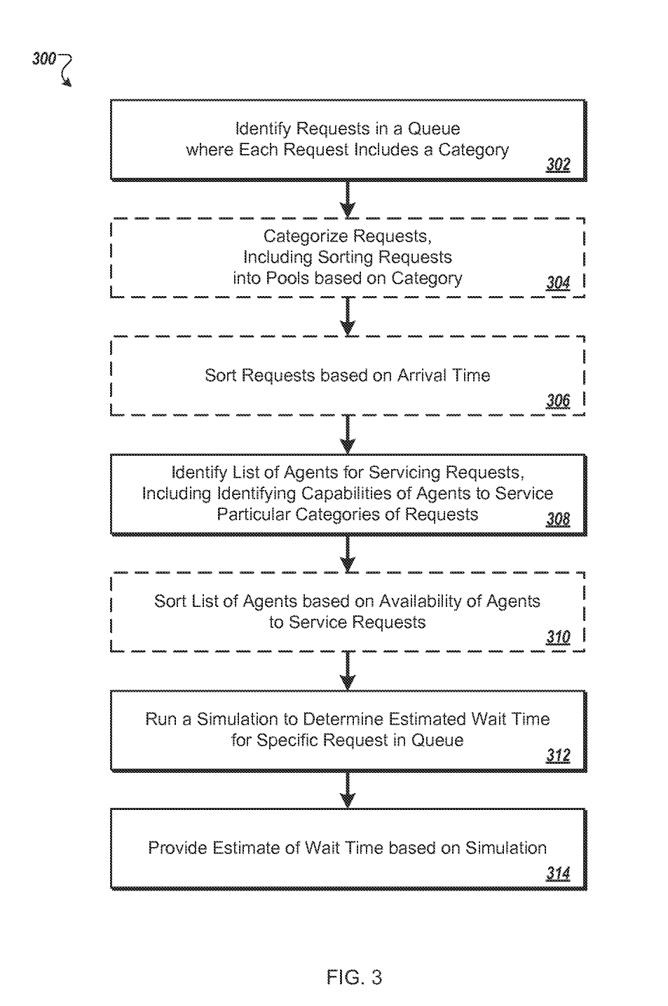

FIG. 3 is a flowchart of an example process 300 for estimating wait times for requests. In some implementations, the process 300 may be performed by the system 100, and will be described as such for purposes of clarity. Briefly, the process 300 includes identifying requests in a queue, categorizing requests, sorting requests based on arrival time, identifying agents for servicing requests, sorting agents based on availability, running a simulation to determine estimated wait times, and providing estimated wait times.

In more detail, a plurality of requests in a queue can be identified (302), where each request includes a category. For example, the request identifier 120 can identify requests in the request queue 140 submitted by the users 104. In some implementations, the requests may be questions posed in a chat help queue. For example, the user 104a can use client device 102a to submit a question to be handled by one or more of the agents 114 through an Internet chat dialog. In the event that a capable agent 104 is not immediately available, for example, the computing server(s) can run a simulation to determine an estimated wait time for the user 104a, and can provide information associated with the wait time for presentation to the user via the client device 102a.

In some implementations, the category may include a topic. For example, the user 104a can specify that the request pertains to troubleshooting a technical problem with a particular product (e.g., a camera). In the present example, the category may be associated with the product or product class (e.g., the particular type of camera, or cameras in general), and the topic may be relative to the category (e.g., troubleshooting a technical problem with the camera). In some implementations, the category may include a topic and a language. For example, the category can include a topic relative to the category for a particular language, such as troubleshooting a technical problem with the camera in English.

In some implementations, requests may be categorized (304). As shown in FIG. 2, for example, categorizing requests can include sorting the requests into a plurality of pools based on the category. For example, using request, topic and/or language information, the computing server(s) 110 (shown in FIG. 1) can associate a particular request with one or more categories.

In some implementations, requests may be sorted (306), based on arrival time. For example, the request queue manager 122 can sort requests in the request queue 140 based on the order received by the computing server(s) 110. As additional requests are submitted by the users 104, for example, the requests can be added to the end of the request queue 140. As requests are handled by the agents 114, for example, the requests can be removed from the request queue 140. In some implementations, the request queue manager 122 can manage multiple request queue copies. For example, a simulation for estimating wait time for a particular request can use a copy of the request queue 140.

A list of agents for servicing the requests can be identified (308), including identifying one or more capabilities of the agents to service particular categories of requests. For example, the agent identifier 124 can access the agents data store 132 to identify capabilities of the agents 114. In the present example, the agent identifier 124 may determine that the agents 114a, 114b have various capabilities, including the capability to handle questions related to troubleshooting technical problems with cameras, and the capability to communicate in English. Thus, both agents 114a, 114b may be identified as having the capability to service such categories of requests as “troubleshooting technical problems”, “cameras”, “troubleshooting technical problems with cameras”, and “troubleshooting technical problems with cameras in English”, depending on the granularity of the request categorization. Additional agent(s) 114n, for example, may or may not be identified as having the capability to service such categories of requests. However, agent(s) 114n may have the capability to service other request categories, potentially freeing one or more agents 114a, 114b to handle the troubleshooting problem of the present example.

In some implementations, the list of agents may be sorted (310), based on the availability of the agents to service requests. For example, the agent list manager 126 can add agents 114 to the agent list 150 (e.g., an array, a list, or another sort of data structure), and can sort the agent list 150 based on agent availability. In the present example, the agent list manager 126 may determine that the agent 114a is currently available (e.g., is not currently handling a user request), and may determine that the agent 114b is currently occupied. Thus, the agent list manager 126 may sort the agents 114a, 114b, such that agent 114a is placed at the top of the agent list 150, and the agent 114b is placed further down the agent list 150. As the availability of the agents 114 to handle requests changes (e.g., as agents log in or out of the system 100, as agents are assigned requests, as agents handle requests, as the efficiency of request handling by agents increases or decreases), the agent list manager 126 may re-sort the agent list 150 to reflect the changes. In some implementations, the agent list manager 126 can manage multiple agent list copies. For example, a simulation for estimating wait time for a particular request can use a copy of the agent list 150.

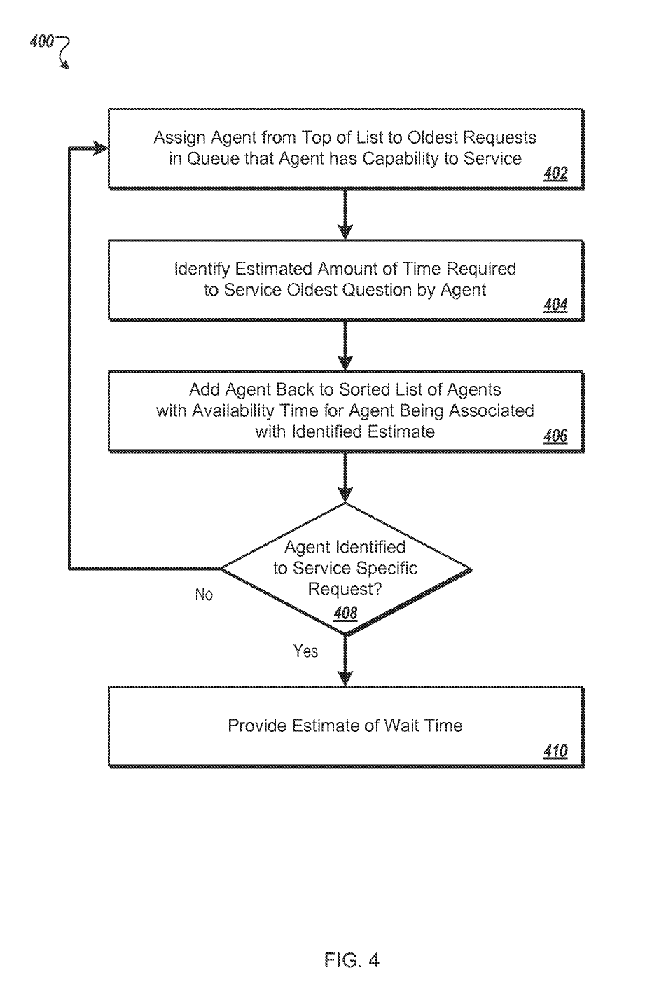

A simulation can be run (312) to determine an estimated wait time for a specific request. In general, the simulation can include assigning agents to service requests based at least in part on capabilities of the agents. An example simulation process is shown in FIG. 4, and will be discussed in further detail below.

In some implementations, an agent's capabilities may be measured in terms of one or more thresholds, and determining in the simulation whether a particular request can be serviced by a given agent can include determining if the agent is sufficiently capable to service the request. For example, the agent identifier 124 can access the agents data store 132 to identify capabilities of each of the agents 114, and can provide such information to the queue simulator 128. The request identifier 120, for example, can identify category, topic, and language information associated with requests submitted by the users 104, and can provide such information to the queue simulator 128. Based on provided information, for example, the queue simulator 128 can match user requests to sufficiently capable agents.

Sufficiency of agent capabilities may be measured based on one or more criteria. In some implementations, the criteria may include a number of other agents in the list of agents that have a minimum capability to service the request. For example, if the request submitted by user 104a is categorized as “troubleshooting technical problems with cameras in English”, the queue simulator 128 may initially identify a subset of the agents 114 (e.g., agents 114a, 114b) in the agent list 150 as being sufficiently capable to handle the request. In the present example, if the criterion for the number of agents is configured to include a greater number of agents, the threshold for agent capability can be lowered to include agents that are capable in regard to such general categories as “troubleshooting technical problems” or “cameras”. As another example, certain agents may be identified as being more or less capable of handling requests of a particular type. If the queue simulator 128 initially identities a greater number of agents 114 in the agent list 150 than the criterion for the number of agents, for example, the threshold for agent capability can be raised such that a lesser number of agents are included. For example, agents may be selected based on an amount of experience handling the type of request, based on an efficiency level, based on an authority level, or some other qualifier.

In some implementations, the criteria may include a number of requests of a given type that are in the queue. For example, if the queue simulator 128 determines that a number of requests related to “troubleshooting technical problems” in the request queue 140 is greater than a certain level, a threshold for measuring an agent's capabilities may be lowered such that the number of agents 114 identified as being sufficiently capable of handling the type of request increases. Correspondingly, if the number of requests is less than a certain level, the threshold may be raised such the number of identified agents 114 decreases. Thus, by considering the number of agents 114 in the agent list 150, and the number of requests of a given type in the request queue 140, thresholds for measuring agent capabilities can be adjusted by the queue simulator 128 to dynamically balance available agents with user requests.

An estimate of wait time can be provided (314) based on the simulation. In the present example, the queue simulator 128 may determine that the agent 114a is capable of servicing a request of the user 104a, and that the agent will be available at a particular time. Information related to the wait time estimate can be provided by the computing server(s) 110 to the user client device 102a and can be presented to the user 104a.

FIG. 4 is a flowchart of an example process 400 for running a simulation to determine estimated wait times. In some implementations, the process 400 may be performed by the queue simulator 128 in the system 100 (shown in FIG. 1), and will be described as such for purposes of clarity. Briefly, the process 400 includes assigning an agent from the top of a list of agents to an oldest request in a request queue that the agent has a capability to service. An estimated amount of time required to service the oldest request can be identified, and the agent can be added back to the sorted agent list with an availability time for the agent being associated with the estimate. The steps may be repeated until a particular agent is identified to service the specific request. Upon identifying the agent, an estimate of wait time may be provided.

In more detail, an agent from the top of a list of agents is assigned (402) to an oldest request in a request queue that the agent has a capability to service. For example, the agent 114a may be currently available, and may be positioned at the top of the agent list 150. The queue simulator 128, for example, can traverse from the top of the request queue 140 toward the bottom, and can determine whether the agent 114a is capable of servicing each of the requests. When a match between a particular request (e.g., based on category) and the capabilities of the agent 114a is identified, for example, the queue simulator 128 can assign the agent 114a to the request.

In some implementations, running the simulation may include removing agents from the simulation if they do not have a capability to service any requests in the queue. For example, if the queue simulator 128 were to determine that the agent 114a does not have the capability to service any of the requests in the request queue 140, the agent 114a may be removed from the simulation. In some implementations, as additional requests are added to the request queue 140, the queue simulator 128 may again include the agent 114a in the simulation. For example, if sorting of requests is based at least in part on priority, additional requests may affect simulation results.

An estimated amount of time required to service the oldest request by the agent is identified (404). For example, the queue simulator 128 can access the requests data store 130 and/or the agents data store 132 to identify historical data related to handling of similar (e.g., based on category) requests by the agent 114a. A historical average of the amount of time spent by the agent 114a handling similar requests can be used to estimate the amount of time required to service the request.

In some implementations, providing the estimate may include compensating for simulation start up error. For example, when beginning the simulation, the queue simulator 128 may determine that the agent 114a is currently handling a user question. To compensate, the queue simulator 128 may adjust an amount of time of delay in answering a first question by the agent 114a by a predetermined amount. In some implementations, the predetermined amount is equal to approximately one half of a historical average. For example, the queue simulator 128 can access the agents data store 132 to identify historical data related to handling of past requests by the agent 114a, and can use the data to calculate an average amount of time for servicing requests. The average amount of time divided by two for servicing requests can be added to the estimated amount of time required to answer a first question by agent in the simulation.

The agent is added (406) back to the sorted list of agents with an availability time for the agent being associated with the identified estimate. For example, each of the agents 114 in the agent list 150 can be associated with an estimated time of availability, based on cumulative estimated times for servicing assigned requests. If the agent 114a is initially positioned at the top of the agent fist 150, for example, the queue simulator 128 can remove the agent from the top position, and can use the estimated amount of time for answering a question by the agent to insert the agent 114a at a different position in the agent list 150. To sort the agent list 150, the queue simulator 128 can compare the estimated availability times for the agents 114. Thus, as agents 114 from the agents list 150 are assigned to requests by the queue simulator 128, their relative positions in the agents list 150 may change.

In some implementations, agents may be capable of working on a plurality of N requests at one time, and may be added back to the sorted list of agents with an availability time for the agent being associated with the estimated time/N. For example, the agent 114a may have the capability to process multiple requests at a time (e.g., by using multiple chat windows, texting sessions, or e-mail exchanges). To account for increased agent efficiency, for example, the queue simulator 128 can identify an estimated amount of time for servicing each request assigned to the agent 114a, and can divide the estimated amount of time for each request by the number of requests that the agent is capable of servicing. The modified time estimate for each assigned request can be accumulated by the queue simulator 128, and can be used for sorting the agent 114a in the agent list 150.

A determination (408) is made of whether an agent is identified to service a specific request. For example, if the queue simulator 128 is to provide a wait time estimate for the request at a specific position in request queue 140, multiple iterations of steps 402, 404, 406 in the process 400 may or may not be necessary for identifying an agent to service the request. If the agent at the top of the agent list 150 is determined to be capable of servicing the request, for example, the estimated wait time for the request may correspond with the availability time of the agent. If the agent at the top of the agent list 150 is determined to be incapable of servicing the request, for example, the next agent is identified as a possibility, and so forth. In some implementations, the simulation may be ended if the list of available agents reaches zero. For example if all of the agents 114 log out of the system 100, the queue simulator 128 may end the simulation. As another example, if the queue simulator 128 is unable to identify an agent 114 capable of handling a particular request, the queue simulator 128 may end the simulation for that request until additional agents log in to the system 100.

An estimate of wait time is provided (410) based on the simulation. For example, the queue simulator 128 can provide wait time estimates for each of the requests in the request list 140, and the computing server(s) 110 may provide estimate information to the users 104. The wait time estimate for a request may correspond with the availability time of a particular agent when the queue simulator 128 assigns the agent to a specific request. For an initially unoccupied agent, for example, a wait time estimate for a first request assigned to the agent may be zero. For the second request assigned to the agent, the estimated wait time may be based on the estimated time for the agent to service the first request. For the third request assigned to the agent, the estimated wait time may be based on the estimated time for the agent to service the first two requests, and so forth.

In some implementations, providing the estimate can include providing an estimate that indicates that no agents are presently available to service the request. For example, if none of the agents 114 are identified by the queue simulator 128 as having the capability to service a request submitted by the user 104b (e.g., the request is submitted in a language in which none of the agents are proficient), the user 104b may be notified of such a condition.

In some implementations, providing the estimate may include determining a number of requests that the identified agent has processed in the simulation prior to being available to process the specific request, and multiplying an average processing time associated with the agent by the number of requests to produce the estimate. For example, the queue simulator 128 may assign the agent 114a to three requests (e.g., questions) before assigning the agent to a specific request. In the present example, the queue simulator 128 can access the requests data store 130 and/or the agents data store 132 to identify an average processing time associated with the agent 114a, and may multiply the average processing time by three to produce an estimated wait time for the specific request.

In some implementations, providing the estimate may include maintaining a cumulative total of estimated handling times for requests that the identified agent has processed in the simulation prior to being available to process the specific request. For example, the queue simulator 128 may assign the agent 114a to three requests (e.g., questions) before assigning the agent to a specific request. In the present example, the queue simulator 128 can access the request data store 130 and/or the agents data store 132 to identify projected processing times (e.g., based on category) for each of the three requests, and can accumulate the projected processing times to produce an estimated wait time for the specific request.

In some implementations, the estimated wait time may be reduced by one half of an average processing time associated with the agent when determining a wait time associated with processing a first request by a given agent. For example, if the agent 114a is handling a request when the simulation begins, the queue simulator 128 can divide the average processing time of the agent 114a by two in order to produce an estimated wait time for the first request assigned to the agent. Thus, the estimated time for the agent 114a to handle an initial ongoing request can be added at the beginning of a simulation, for example, when estimating wait times for subsequent requests.

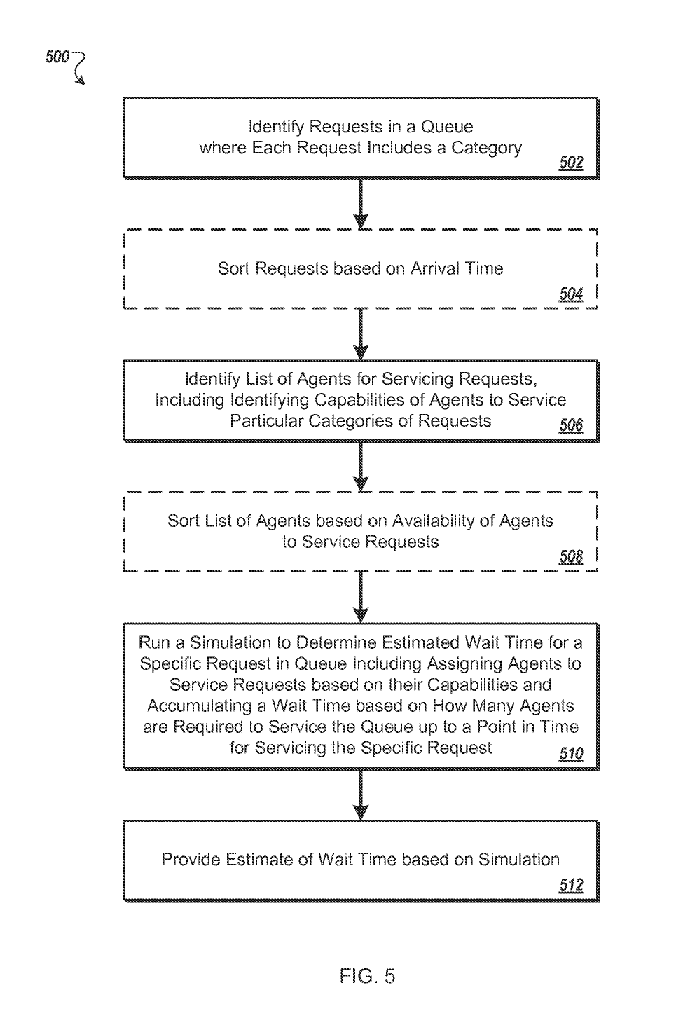

FIG. 5 is a flowchart of an example process 500 for estimating wait times for requests. In some implementations, the process 500 may be performed by the system 100, and will be described as such for clarity. Briefly, the process 500 includes identifying requests in a queue, sorting the requests, identifying a list of agents for servicing the requests, sorting the list of agents based on agent availability, running a simulation to determine estimated wait time for a specific request, and providing an estimate of the wait time.

A plurality of requests in a queue can be identified (502). In some implementations, each request may include a category. For example, the request identifier 120 can identify requests submitted by the users 104 (e.g., using client devices 102) in the request queue 140. Each of the requests may be associated with category, topic, and/or language information.

In some implementations, the requests may be sorted (504) based on arrival time. For example, as requests are received by the computing server(s) 110, the request queue manager 122 can add the requests to the end of the request queue 140. As requests are handled by agents 114, for example, the requests queue manager 122 can remove the requests from the queue 140.

In some implementations, the requests may be sorted based et least in part on priority. For example, one or more of the users 104 may have a service agreement with an organization (e.g., a business) managing the agents 114. Requests from preferred users 104, for example, may receive priority from the computing server(s) 110 when assigning the requests to agents 114.

A list of agents can be identified (506) for servicing the requests. In some implementations, the identifying may include identifying one or more capabilities of the agents to service particular categories of requests. For example, the agent identifier 124 can identify agents 114 in the agent list 150, and can identify agent capabilities by referencing the agents data store 132.

In some implementations, the list of agents may be sorted (508) based on the availability of the agents to service requests. For example, the agent list manager 126 can sort the agent list 150 based on availability of each of the agents 114. The agent list manager 126 may consider factors including availability times of the agents, ability of the agents to handle multiple requests concurrently, ability of the agents to handle particular categories of requests, experience levels of the agents and/or efficiency levels of the agents, when sorting the agent list 150.

A simulation can be run (510) to determine estimated wait time for a specific request. For example, the queue simulator 128 can run the simulation for a specific request in the request queue 140. The simulation can include assigning agents to service requests based on their capabilities and accumulating a wait time based on how many agents are required to service the queue up to a point in time for servicing the specific request. For example, the queue simulator 128 can progressively assign agents 114 to user requests, based on the capabilities of the agents 114. In general, estimated wait times for requests may be based on the accumulated wait times for the agents required to service the queue. The estimated wait time for the specific request, for example, may be associated with the accumulated wait time for the agent eventually assigned to the request. In some implementations, estimated wait times may be based in part on request priority. For example, requests from preferred users 104 (e.g., users having a service level agreement) may be promoted to the front of the request queue 140, or may receive an improved position in the queue (e.g., moved toward the front).

An estimate of the wait time can be provided (512), based on the simulation. For example, the computing server(s) 110 may provide estimated wait time information to the client devices 102, for presentation to the users 104.

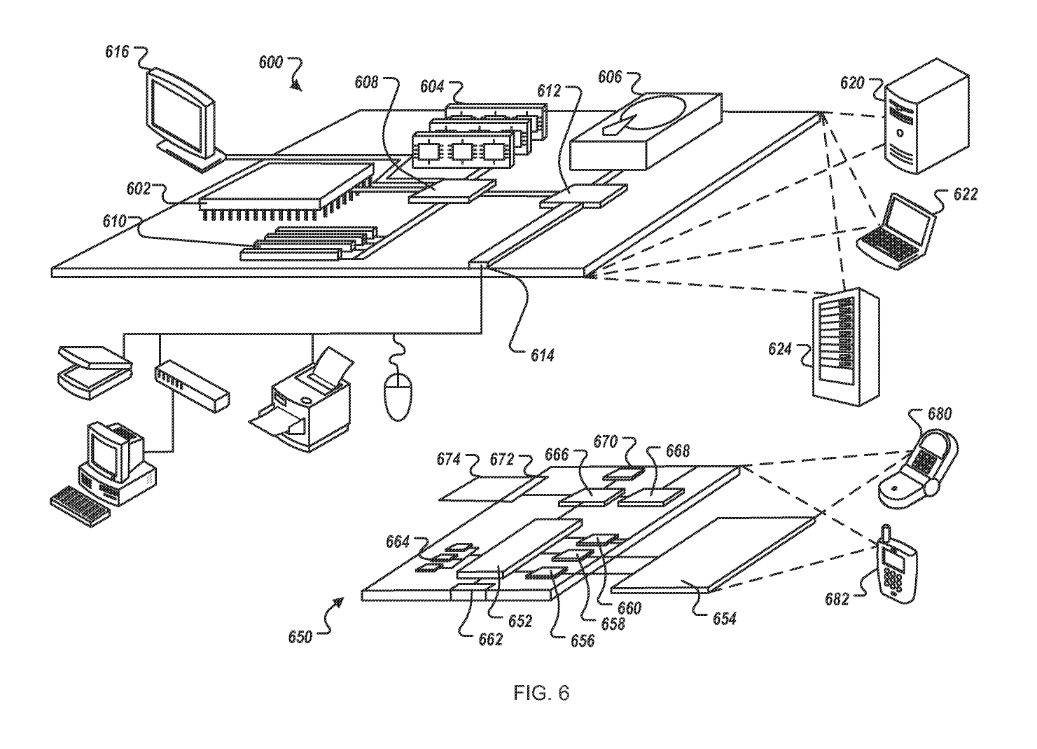

FIG. 6 shows an example of a generic computer device 600 and a generic mobile computer device 650, which may be used with the techniques described here. Computing device 600 is intended to represent various forms of digital computers, such as laptops, desktops, workstations, personal digital assistants, servers, blade servers, mainframes, and other appropriate computers. Computing device 650 is intended to represent various forms of mobile devices, such as personal digital assistants, cellular telephones, smartphones, and other similar computing devices. The components shown here, their connections and relationships, and their functions, are meant to be exemplary only, and are not meant to limit implementations of the inventions described and/or claimed in this document.

Computing device 600 includes a processor 602, memory 604, a storage device 606, a high-speed interface 608 connecting to memory 604 and high-speed expansion ports 610, and a low speed interface 612 connecting to low speed bus 614 and storage device 606. Each of the components 602, 604, 606, 608, 610, and 612, are interconnected using various busses, and may be mounted on a common motherboard or in other manners as appropriate. The processor 602 can process instructions for execution within the computing device 600, including instructions stored in the memory 604 or on the storage device 606 to display graphical information for a GUI on an external input/output device, such as display 616 coupled to high speed interface 608. In other implementations, multiple processors and/or multiple buses may be used, as appropriate, along with multiple memories and types of memory. Also, multiple computing devices 600 may be connected, with each device providing portions of the necessary operations (e.g., as a server bank, a group of blade servers, or a multi-processor system).

The memory 604 stores information within the computing device 600. In one implementation, the memory 604 is a volatile memory unit or units. In another implementation, the memory 604 is a non-volatile memory unit or units. The memory 604 may also be another form of computer-readable medium, such as a magnetic or optical disk.

The storage device 606 is capable of providing mass storage for the computing device 600. In one implementation, the storage device 606 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 604, the storage device 606, memory on processor 602, or a propagated signal.

The high speed controller 608 manages bandwidth-intensive operations for the computing device 600, while the low speed controller 612 manages lower bandwidth-intensive operations. Such allocation of functions is exemplary only. In one implementation, the high-speed controller 608 is coupled to memory 604, display 616 (e.g., through a graphics processor or accelerator), and to high-speed expansion ports 610, which may accept various expansion cards (not shown). In the implementation, low-speed controller 612 is coupled to storage device 606 and low-speed expansion port 614. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 600 may be implemented in a number of different forms, as shown in the figure. For example, it may be implemented as a standard eerier 620, or multiple times in a group of such servers. It may also be implemented as part of a rack server system 624. In addition, it may be implemented in a personal computer such as a laptop computer 622. Alternatively, components from computing device 600 may be combined with other components in a mobile device (not shown), such as device 650. Each of such devices may contain one or more of computing device 600, 650, and an entire system may be made up of multiple computing devices 600, 650 communicating with each other.

Computing device 650 includes a processor 652, memory 664, an input/output device such as a display 654, a communication interface 666, and a transceiver 668, among other components. The device 650 may also be provided with a storage device, such as a microdrive or other device, to provide additional storage. Each of the components 650, 652, 664, 654, 666, and 668, are interconnected using various buses, and several of the components may be mounted on a common motherboard or in other manners as appropriate.

The processor 652 can execute instructions within the computing device 650, including instructions stored in the memory 664. The processor may be implemented as a chipset of chips that include separate and multiple analog and digital processors. The processor may provide, for example, for coordination of the other components of the device 650, such as control of user interfaces, applications run by device 650, and wireless communication by device 650.

Processor 652 may communicate with a user through control interface 658 and display interface 656 coupled to a display 654. The display 654 may be, for example, a TFT LCD (Thin-Film-Transistor Liquid Crystal Display) or an OLED (Organic Light Emitting Diode) display, or other appropriate display technology. The display interface 656 may comprise appropriate circuitry for driving the display 654 to present graphical and other information to a user. The control interface 658 may receive commands from a user and convert them for submission to the processor 652. In addition, an external interface 662 may be provide in communication with processor 652, so as to enable near area communication of device 650 with other devices. External interface 662 may provide, for example, for wired communication in some implementations, or for wireless communication in other implementations, and multiple interfaces may also be used.

The memory 664 stores information within the computing device 650. The memory 664 can be implemented as one or more of a computer-readable medium or media, a volatile memory unit or units, or a non-volatile memory unit or units. Expansion memory 674 may also be provided and connected to device 650 through expansion interface 672, which may include, for example, a SIMM (Single In Line Memory Module) card interface. Such expansion memory 674 may provide extra storage space for device 650, or may also store applications or other information for device 650. Specifically, expansion memory 674 may include instructions to carry out or supplement the processes described above, and may include secure information also. Thus, for example, expansion memory 674 may be provide as a security module for device 650, and may be programmed with instructions that permit secure use of device 650. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 664, expansion memory 674, memory on processor 652, or a propagated signal that may be received, for example, over transceiver 668 or external interface 662.

Device 650 may communicate wirelessly through communication interface 666, which may include digital signal processing circuitry where necessary. Communication interface 666 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 668. In addition, short-range communication may occur, such as using a Bluetooth, WiFi, or other such transceiver (not shown). In addition, GPS (Global Positioning System) receiver module 670 may provide additional navigation- and location-related wireless data to device 650, which may be used as appropriate by applications running on device 650.

Device 650 may also communicate audibly using audio codec 660, which may receive spoken information from a user and convert it to usable digital information. Audio codec 660 may likewise generate audible sound for a user, such as through a speaker, e.g., in a handset of device 650. Such sound may include sound from voice telephone calls, may include recorded sound (e.g., voice messages, music files) and may also include sound generated by applications operating on device 650.

The computing device 650 may be implemented in a number of different forms, as shown in the figure. For example, it may be implemented as a cellular telephone 680. It may also be implemented as part of a smartphone 682, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments have been described. Nevertheless, it will be Understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1.-24. (canceled)

25. A method for providing users with estimated wait times for servicing requests, the method comprising:
receiving, by a computing server, a request submitted by a user via a client device;
adding the received request to a requests queue comprising a plurality of requests;
identifying a plurality of agents available to service the plurality of requests, based on a respective capability of each of the agents to service one or more categories of requests, and identifying a respective availability time for each of the plurality of agents, wherein the respective capability of each of the agents involves at least one of an amount of experience, an efficiency level, and an authority level;
running, responsive to receiving the request submitted by the user, a simulation based on the capabilities of the agents and the availability times for the agents to determine an estimated wait time for the request submitted by the user; and
presenting the estimated wait time to the user via the client device.

26. The method of claim 25, wherein running the simulation comprises:
assigning an agent having an earliest availability time to an oldest request in the requests queue that the agent has a capability to service;
estimating an amount of time required to service the oldest request;
updating the availability time for the agent based on the estimated amount of time required to service the oldest request; and
repeating the assigning, estimating, and updating steps until an agent is assigned to the request submitted by the client device.

27. The method of claim 26, wherein estimating an amount of time required to service the oldest request comprises:
identifying an attribute of the agent assigned to the oldest request, the attribute comprising at least one of an experience level or an efficiency level; and
using the identified attribute to estimate the amount of time for the agent to service the oldest request.

28. The method of claim 26, wherein estimating an amount of time required to service the oldest request comprises:
accessing a requests data store to identify a history of times required by the plurality of agents to service previous requests in a same category as the oldest request;
calculating a historical average of the identified times required to service previous requests in the same category as the oldest request; and
using the historical average as the estimated amount of time to service the oldest request.

29. The method of claim 26, wherein estimating an amount of time required to service the oldest request comprises:
accessing an agents data store to identify a history of times required by the agent assigned to the oldest request to service previous requests;
calculating a historical average of the times required by the agent assigned to the oldest request to service previous requests; and
using the historical average as the estimated amount of time to service the oldest request.

30. The method of claim 26, wherein estimating an amount of time required to service the oldest request comprises:
determining whether the agent assigned to the oldest request is capable of concurrently servicing multiple requests; and
in response to a determination that the agent is capable of concurrently servicing multiple requests, updating the availability time for the agent based on a number of concurrent requests that the agent is capable of servicing.

31. The method of claim 30, wherein updating the availability time for the agent assigned to the oldest request comprises:
determining the number of requests that the agent is capable of concurrently servicing;
calculating a modified servicing time by dividing the estimated amount of time required to service the oldest request by the number of requests that the agent is capable of concurrently servicing; and
adding the modified servicing time to the availability time for the agent assigned to the oldest request.

32. The method of claim 25, further comprising:
generating a list of the plurality of agents available to service requests; and
sorting the list according to the availability times for the plurality of agents, wherein the availability time for an agent is an earliest time at which the agent is available to service a request.

33. The method of claim 25, further comprising:
identifying one or more of the plurality of agents currently servicing a request at a time the simulation is started;
estimating a time required for each of the identified agents to finish servicing the request currently being serviced by the agent; and
updating the availability time for each of the identified agents based on the estimated time required for the agent to finish servicing the request currently being serviced by the agent.

34. The method of claim 33, wherein estimating the time required for each of the identified agents to finish servicing the request currently being serviced by the agent comprises, for each of the identified agents:
accessing a data store to identify a history of times required by the agent to service previous requests;
calculating a historical average of the times required by the agent to service previous requests; and
using one half of the historical average as the estimated time required to finish servicing the request currently being serviced by the agent.

35. A system for providing users with estimated wait times for servicing requests, the system comprising:
a computing device configured to:
receive a request submitted to the computing device by a user via a client device;
add the received request to a requests queue comprising a plurality of requests;
identify a plurality of agents available to service the plurality of requests, based on a respective capability of each of the agents to service one or more categories of requests, and identify a respective availability time for each of the plurality of agents, wherein the respective capability of each of the agents involves at least one of an amount of experience, an efficiency level, and an authority level;
run, responsive to receiving the request submitted by the user, a simulation based on the capabilities of the agents and the availability times for the agents to determine an estimated wait time for the request submitted by the user; and
present the estimated wait time to the user via the client device.

36. The system of claim 35, wherein running the simulation comprises:
assigning an agent having an earliest availability time to an oldest request in the requests queue that the agent has a capability to service;
estimating an amount of time required to service the oldest request;
updating the availability time for the agent based on the estimated amount of time required to service the oldest request; and
repeating the assigning, estimating, and updating steps until an agent is assigned to the request submitted by the client device.

37. The system of claim 36, wherein estimating an amount of time required to service the oldest request comprises:
identifying an attribute of the agent assigned to the oldest request, the attribute comprising at least one of an experience level or an efficiency level; and
using the identified attribute to estimate the amount of time for the agent to service the oldest request.

38. The system of claim 36, wherein estimating an amount of time required to service the oldest request comprises:
accessing a data store to identify a history of times required to service previous requests;
calculating a historical average of the identified times required to service the previous requests; and
using the historical average as the estimated amount of time to service the oldest request.

39. The system of claim 36, wherein estimating an amount of time required to service the oldest request comprises:
determining whether the agent assigned to the oldest request is capable of concurrently servicing multiple requests; and
in response to a determination that the agent is capable of concurrently servicing multiple requests, updating the availability time for the agent based on a number of concurrent requests that the agent is capable of servicing.

40. The system of claim 39, wherein updating the availability time for the agent assigned to the oldest request comprises:
determining the number of requests that the agent is capable of concurrently servicing;
calculating a modified servicing time by dividing the estimated amount of time required to service the oldest request by the number of requests that the agent is capable of concurrently servicing; and
adding the modified servicing time to the availability time for the agent assigned to the oldest request.

41. A method for providing users with estimated wait times for servicing requests, the method comprising:
receiving, by a computing server, a request submitted by a user via a client device;
adding the received request to a requests queue comprising a plurality of requests;
identifying a plurality of agents for servicing the plurality of requests;
running, responsive to receiving the request submitted by the user, a simulation to determine an estimated wait time for the request submitted by the user, wherein the simulation is based at least in part on capability of the plurality of agents, and wherein capability of the agents involves at least one of an amount of experience, an efficiency level, and an authority level; and
presenting the estimated wait time to the user via the client device.

42. (canceled)

43. The method of claim 41, wherein each of the plurality of agents has an availability time;
wherein the simulation to determine the estimated wait time for the request submitted by the client device is based on the availability times for the agents.

44. The method of claim 43, wherein running the simulation comprises:
assigning an agent having an earliest availability time to an oldest request in the requests queue that the agent has a capability to service;
estimating an amount of time required to service the oldest request;
updating the availability time for the agent based on the estimated amount of time required to service the oldest request; and
repeating the assigning, estimating, and updating steps until an agent is assigned to the request submitted by the client device.

45. The method of claim 25, further comprising:
running a second simulation, subsequent to providing the estimated wait time to the client device, the second simulation based on a set of updated availability times for the agents to determine a recalculated estimated wait time for the request submitted by the client device; and
providing the recalculated estimated wait time to the client device.

46. The system of claim 35, the computing device further configured to:
run a second simulation, subsequent to providing the estimated wait time to the client device, the second simulation based on a set of updated availability times for the agents to determine a recalculated estimated wait time for the request submitted by the client device; and
provide the recalculated estimated wait time to the client device.
